(19) United States
(12) Patent Application Publication
(10) Pub. No.: US 2006/0085377 A1
(43) Pub. Date: Apr. 20, 2006

(54) Error information record storage for persistence across power loss when operating system files are inaccessible

(75) Inventors: David F. Mannenbach, Tucson, AZ (US); Brian A. Rinaldi, Tucson, AZ (US); Michael A. Wifall, Tucson, AZ (US)

Correspondence Address: SCULLY, SCOTT, MURPHY, & PRESSER, 400 GARDEN CITY PL, GARDEN CITY, NY, 11530, US

(73) Assignee: INTERNATIONAL BUSINESS MACHINES CORPORATION, ARMONK, NY (US)

(21) Appl. No.: 10/965,982

(22) Filed: Oct. 15, 2004

(51) Int. Cl. G06F 17/30

(52) U.S. Cl. 707/1

(57) ABSTRACT

Records such as error information records are stored across a power loss in a data storage system so that the records can be retrieved following a power loss without the use of a file management system of an operating system of the data storage system. Records are generated for system events such as errors, buffered, and stored in a raw data storage device such as a disk device without the use of a file management system. Following a power loss and subsequent restoring of power, the records are read again without the benefit of the file management system, and processed.

### BACKGROUND OF THE INVENTION

1. Field of the Invention

The invention relates generally to the field of computer systems and, more specifically, to a technique for use in a data storage system for storing records for system events across a power loss when a file management system used by an operating system of the data storage system is unavailable.

2. Description of the Related Art

Data storage systems such as storage servers as commonly used by corporations and other organizations have high-capacity disk arrays to store large amounts of data from external host systems. A data storage system may also backup data from another data storage system, such as at a remote site. The IBM® Enterprise Storage Server (ESS) is an example of such a data storage system. Such systems can access arrays of disks or other storage media to store and retrieve data. Moreover, redundant capabilities may be provided as a further safeguard against data loss. For example, the IBM ESS is a dual cluster storage server that includes two separate server clusters that can access the same storage disks.

In data storage systems, various events may occur. An event can be generated, e.g., for a problem, for the resolution of a problem, or for the successful completion of a task. Examples of events include the normal starting and stopping of a process, the abnormal termination of a process, and the malfunctioning of a server. When error events occur, for instance, corresponding error information records are generated. Events that are non-errors are also logged for information. Typically, such records are written to non-volatile random access memory (NVRAM), which is a battery-backed memory, so that the records will persist across a power loss in the data storage system. However, NVRAM typically has space for only one record to be saved, such as one AIX log, while the server is running, for performance reasons. The cost of increasing the NVRAM space is high due to the cost of NVRAM and its batteries. Moreover, a file management system, e.g., file system, of the operating system of the data storage system, which coordinates how the device organizes and keeps track of files, is not available to recover the error information record immediately after the power to the data storage system is restored. Accordingly, the file management system cannot be used to recover the records.

### BRIEF SUMMARY OF THE INVENTION

To overcome these and other deficiencies in the prior art, the present invention provides a technique for storing records such as error information records across a power loss in a data storage system so that the records can be retrieved following a power loss without the use of a file management system of an operating system of the data storage system.

In a particular aspect of the invention, at least one program storage device tangibly embodies a program of instructions executable by at least one processor to perform a method for storing records in a data storage system, wherein an operating system in the data storage system uses a file management system to manage files stored in the data storage system, and records are generated for system events detected in the data storage system. The method includes writing the records to at least one raw storage device without using the file management system, and recovering the records from the at least one raw storage device following an occurrence in the data storage system in which the file management system used by the operating system is temporarily unavailable.

In another aspect of the invention, at least one program storage device, tangibly embodying a program of instructions executable by at least one processor to perform a method for storing records in a data storage system, is provided. The method includes: providing an operating system which uses a file management system to manage files -stored in the data storage system, generating records for system events detected in the data storage system, writing the records to at least one raw storage device without using the file management system, and recovering the records from the at least one raw storage device following an occurrence in the data storage system in which the file management system used by the operating system is temporarily unavailable.

At least one program storage device of the above-mentioned type is also provided where the occurrence includes a power loss in the data storage system, and the records are recovered from the at least one raw storage device following a restoration of power to the data storage system.

Related computer-implemented methods and data storage systems are also provided.

### BRIEF DESCRIPTION OF THE DRAWINGS

These and other features, benefits and advantages of the present invention will become apparent by reference to the following text and figures, with like reference numbers referring to like structures across the views, wherein:

FIG. 1 illustrates a data storage system according to the invention; and

FIG. 2 illustrates a method for storing and recovering records according to the invention.

### DETAILED DESCRIPTION OF THE INVENTION

A data storage system can be in a state where the operating system file systems are inaccessible, such as following a power loss and restoration of power. Other conditions could exist as well where the file systems are unavailable, such as a software failure. In such a state, the persistence across a power loss of records such as error information records is needed in case a utility power loss is encountered. However, the records cannot be stored in regular, volatile memory since this memory will be cleared by a power loss. In a situation where the data storage system needs to perform various operations when the operating system file systems are not available, the capacity to store multiple records so that they are persistent across a power loss is required. The various operations may include, e.g., writing modified non-recreatable data for data integrity across power loss, which requires disk accesses, SCSI bus access, etc. Moreover, the file systems cannot be used because they are also not available immediately after restoration of the power.

According to the invention, the data storage system may use a raw storage device such as a disk drive to write records to, and read records from, without employing a file system, so that the records can be directly recovered following restoration of power to the data storage system. In one possible implementation, error information records are written to the raw storage device so that they will persist across a power loss, and can be read after power is restored and the data storage system is brought up. This functionality can be achieved, in one possible approach, by providing a kernel extension to the operating system of the data storage system. The kernel extension provides the capability to write records to one or more raw disk devices without file systems for many of its processes. The raw disk devices can be separate from the disk storage resources used by the operating system, e.g., to store customer data. When the records are generated, they may be first stored in a buffer, and then written to the raw storage device. Once written to the raw storage device, such as a magnetic or optical disk, the records are persistent across a power loss because the type of storage media used does not require power to maintain its data. When power to the data storage system is restored following the power loss, the records are read from the raw storage device and processed.

The invention is illustrated below in the context of a dual-cluster storage server such as the IBM ESS. However, the invention may be adapted for use with any data storage system, whether or not it has such redundancy, and otherwise regardless of configuration.

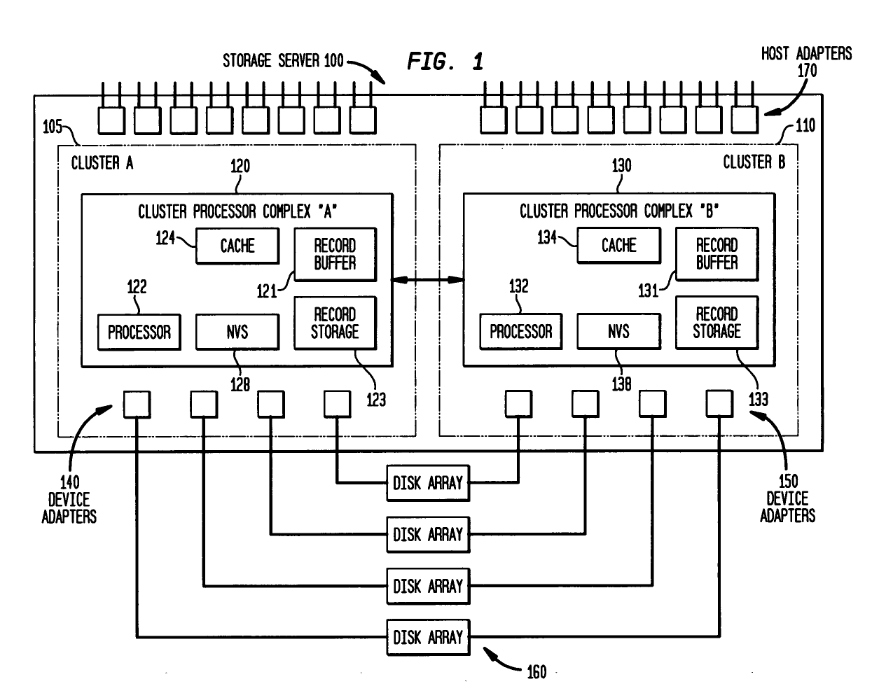

FIG. 1 illustrates a data storage system according to the invention. A data storage system or storage server 100, which may an IBM Enterprise Storage Server (ESS), for instance, is a high-capacity storage device that can back up data from a variety of different devices. For example, a large corporation or other enterprise may have a network of servers that each store data for a number of workstations used by individual employees. Periodically, the data on the host servers is backed up to the high-capacity data storage system 100 to avoid data loss if the host servers malfunction. The data storage system 100 can also provide data sharing between host servers since it is accessible to each host server. The data storage system 100 has redundant resources to provide an additional safeguard against data loss. As a further measure, the data of the data storage system 100 may be mirrored to another storage server, typically at a remote site. A user interface may be provided to allow a user to access information regarding the status of the data storage system 100.

The example data storage system 100 includes two clusters for redundancy. Each cluster 105, 110, e.g., “A” and “B”, respectively, works independently, with its own operating system and kernel extension, and may include cluster processor complexes 120, 130 with cluster cache 124, 134, nonvolatile storage (NVS) 128, 138, and device adapters 140, 150. The device adapters (DA) 140, 150 are used to connect disks in the disk arrays 160 to the cluster processor complexes 120, 130. Each cluster 105, 110 contains four device adapters 140, 150. Each adapter is part of a pair, one on each cluster. A pair supports two independent paths to all of the disk drives served by the pair. Each disk array is configured to be accessed by only one of the clusters. However, if a cluster failure occurs, the surviving cluster automatically takes over all of the disks. The disk arrays or ranks 160 can be configured as RAID 5 (redundant array of independent disks) or non-RAID arrays. Alternatively, another high-capacity storage medium may be used.

Processors 122 and 132 execute instructions such as software, firmware and/or micro code, to achieve the functionality described herein. The software may be stored in any type of memory resources that are available to the processors 122 and 132, as will be apparent to those skilled in the art. Such memory resources are considered to be program storage devices.

Host adapters (HAs) 170 are external interfaces that may support two ports, e.g., either small computer systems interface (SCSI) or IBM's enterprise systems connection (ESCON), which is an Enterprise Systems Architecture/390 and zSeries computer peripheral interface. Each HA connects to both cluster processor complexes 120, 130 so that either cluster can handle I/Os from any host adapter. The data storage system 100 contains four host-adaptor bays, each of which is connected to both clusters 105, 110 for redundancy.

Each cluster further includes a record buffer 121 or 131 and a record storage device 123 or 133 as the raw storage device. The raw storage device 123 or 133 may be a disk device, for example. As mentioned, records related to system events such as errors may be buffered in the buffers 121 or 131 before being written to the respective raw data storage devices 123 or 133. The records may also be stored in the buffers 121 or 131 after being read from the raw data storage devices 123 or 133.

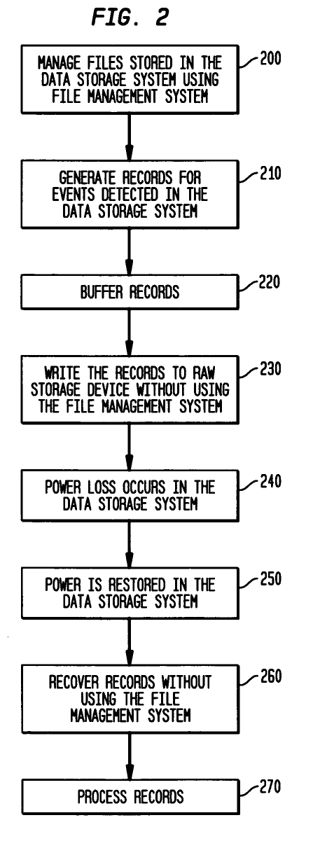

FIG. 2 illustrates a method for storing and recovering records according to the invention. At block 200, the operating system of the data storage system, or of each cluster of a multi-cluster data storage system, uses a file management system to manage files stored in the data storage system, such as in the disk arrays 160. At block 210, the kernel extension to the operating system (OS), e.g., executing in the processors 122 or 132, generates records for events that are detected in the local cluster of the data storage system, or in the data storage system overall, such as error events or any other type of event. The kernel extension runs on top of the operating system and monitors software running on the operating system. Generally, logging can occur for multiple errors of any type, or any other event that can be detected by the kernel extension. Errors are detected by a device driver. Sometimes, events are detected when the operating system has file systems enabled, and sometimes they are detected when the operating system does not have file systems enabled, such as after a power failure. At block 220, the records are buffered, such as in the buffer 121 or 131. Periodically, such as based on a fixed time interval, or when the buffer 121 or 131 is becoming full, the records are written to the raw storage device 123 or 133 without using the file management system (block 230). In particular, this may be accomplished by using raw disk inpuit/output access, using character raw disk devices, in which no file system is required. Additional records that are subsequently generated can replace those already in the buffer 121 or 131, such as by overwriting the oldest records first.

At block 240, a power loss occurs in the data storage system, such as due to a utility power failure. After some period of time, the power is restored to the data storage system (block 250). At this time, the records are recovered from the raw data storage device 123 or 133, again without using the file management system (block 260). The records may be read, still with raw disk access, at any time, such as after an initial program load (IPL). IPL involves loading software such as the operating system and the kernel extension into the working memory of the processor 122 or 132. Finally, at block 270, the recovered records are processed, such as by reading the records using the raw disk access, and transferring them from the kernel extension to a storage controller device driver.

Accordingly, it can be seen that the invention provides a technique for providing persistent storage of multiple event information records when operating system file systems are not available. A raw data storage device such as a disk drive provides persistent storage to preserve the event information records across a power loss. The device is sized and configured to hold multiple event information records. The storage can be accessed when the operating system file systems are not available. In one possible embodiment, a kernel extension to the operating system uses the raw data storage device to store and log multiple event information records. Moreover, the event information records may store any type of system error or event that is detected by the kernel extension, along with information about the error or event, such as the time it was generated, codes that describe the error or event, or a source of the error, the sector on the drive being accessed at the time of the error, and the drive that had the failure. The invention is applicable generally to any environment where operating system file systems are not available.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

What is claimed is:

1. At least one program storage device, tangibly embodying a program of instructions executable by at least one processor to perform a method for storing records in a data storage system, wherein an operating system in the data storage system uses a file management system to manage files stored in the data storage system, and records are generated for system events detected in the data storage system, the method comprising:
writing the records to at least one raw storage device without using the file management system; and
recovering the records from the at least one raw storage device following an occurrence in the data storage system in which the file management system used by the operating system is temporarily unavailable.

2. The at least one program storage device of claim 1, wherein:
the writing and recovering are handled by a kernel extension of the operating system.

3. The at least one program storage device of claim 1, wherein:
the at least one raw storage device comprises at least one disk; and
the writing the records uses a raw disk access.

4. The at least one program storage device of claim 1, wherein:
the occurrence comprises a power loss in the data storage system, and the records are recovered from the at least one raw storage device following a restoration of power to the data storage system.

5. The at least one program storage device of claim 1, wherein:
the records are recovered from the at least one raw storage device without using the file management system.

6. The at least one program storage device of claim 1, wherein the method further comprises:
buffering the records in a buffer;
wherein the records are written to the at least one raw storage device from the buffer.

7. The at least one program storage device of claim 1, wherein:
the at least one raw storage device stores multiple records written thereto.

8. The at least one program storage device of claim 1, wherein:
the records provide information describing the system events detected in the data storage system.

9. The at least one program storage device of claim 1, wherein:
the system events comprise errors, and the records comprise error information records describing the errors.

10. A computer-implemented method for storing records in a data storage system, wherein an operating system in the data storage system uses a file management system to manage files stored in the data storage system, and records are generated for system events detected in the data storage system, the method comprising:
writing the records to at least one raw storage device without using the file management system; and
recovering the records from the at least one raw storage device following an occurrence in the data storage system in which the file management system used by the operating system is temporarily unavailable.

11. The computer-implemented method of claim 10, wherein:
the at least one raw storage device comprises at least one disk; and
the writing the records uses a raw disk access.

12. The computer-implemented method of claim 10, wherein:
the occurrence comprises a power loss in the data storage system, and the records are recovered from the at least one raw storage device following a restoration of power to the data storage system.

13. The computer-implemented method of claim 10, wherein:
the records are recovered from the at least one raw storage device without using the file management system.

14. The computer-implemented method of claim 10, wherein:
the system events comprise errors, and the records comprise error information records describing the errors.

15. A data storage system for storing records, wherein an operating system in the data storage system uses a file management system to manage files stored in the data storage system, and records are generated for system events detected in the data storage system, the data storage system comprising:
means for writing the records to at least one raw storage device without using the file management system; and
means for recovering the records from the at least one raw storage device following an occurrence in the data storage system in which the file management system used by the operating system is temporarily unavailable.

16. At least one program storage device, tangibly embodying a program of instructions executable by at least one processor to perform a method for storing records in a data storage system, the method comprising:
providing an operating system which uses a file management system to manage files stored in the data storage system;
generating records for system events detected in the data storage system;
writing the records to at least one raw storage device without using the file management system; and
recovering the records from the at least one raw storage device following an occurrence in the data storage system in which the file management system used by the operating system is temporarily unavailable.

17. The at least one program storage device of claim 16, wherein:
the writing and recovering are handled by a kernel extension to the operating system.

18. The at least one program storage device of claim 16, wherein:
the at least one raw storage device comprises at least one disk; and
the writing the records uses a raw disk access.

19. The at least one program storage device of claim 16, wherein:
the occurrence comprises a power loss in the data storage system, and the records are recovered from the at least one raw storage device following a restoration of power to the data storage system.

20. The at least one program storage device of claim 16, wherein:
the records are recovered from the at least one raw storage device without using the file management system.

21. The at least one program storage device of claim 16, wherein:
the records provide information describing the system events detected in the data storage system.

22. The at least one program storage device of claim 16, wherein:
the system events comprise errors, and the records comprise error information records describing the errors.

23. A computer-implemented method for storing records in a data storage system, comprising:
providing an operating system which uses a file management system to manage files stored in the data storage system;
generating records for system events detected in the data storage system;
writing the records to at least one raw storage device without using the file management system; and
recovering the records from the at least one raw storage device following an occurrence in the data storage system in which the file management system used by the operating system is temporarily unavailable.

24. The computer-implemented method of claim 23, wherein:
the occurrence comprises a power loss in the data storage system, and the records are recovered from the at least one raw storage device following a restoration of power to the data storage system.

25. The computer-implemented method of claim 23, wherein:
the records are recovered from the at least one raw storage device without using the file management system.

26. A data storage system for storing records, comprising:
means for providing an operating system which uses a file management system to manage files stored in the data storage system;
means for generating records for system events detected in the data storage system;
means for writing the records to at least one raw storage device without using the file management system; and
means for recovering the records from the at least one raw storage device following an occurrence in the data storage system in which the file management system used by the operating system is temporarily unavailable.

27. At least one program storage device, tangibly embodying a program of instructions executable by at least one processor to perform a method for storing records in a data storage system, the method comprising:
providing an operating system which uses a file management system to manage files stored in the data storage system;
generating records for system events detected in the data storage system;
writing the records to at least one raw storage device without using the file management system; and
recovering the records from the at least one raw storage device following an occurrence in the data storage system in which the file management system used by the operating system is temporarily unavailable; wherein:
the occurrence comprises a power loss in the data storage system, and the records are recovered from the at least one raw storage device following a restoration of power to the data storage system, and without using the file management system.

28. A data storage system for storing records, wherein an operating system in the data storage system uses a file management system to manage files stored in the data storage system, and records are generated for system events detected in the data storage system, the data storage system comprising:
at least one raw storage device;
means for writing the records to the at least one raw storage device without using the file management system; and
means for recovering the records from the at least one raw storage device following an occurrence in the data storage system in which the file management system used by the operating system is temporarily unavailable; wherein:
the occurrence comprises a power loss in the data storage system, and the records are recovered from the at least one raw storage device following a restoration of power to the data storage system, and without using the file management system.
